(19) United States
(12) Patent Application Publication
(10) Pub. No.: US 2023/0294419 A1
(43) Pub. Date: Sep. 21, 2023

(54) RECORDING APPARATUS

(71) Applicant: SEIKO EPSON CORPORATION, Tokyo (JP)

(72) Inventors: Ryuji MORIYAMA, Matsumoto-shi (JP); Yoshihiko MOMOSE, Shiojiri-shi (JP)

(21) Appl. No.: 18/184,149

(22) Filed: Mar. 15, 2023

(30) Foreign Application Priority Data
Mar. 16, 2022 (JP) 2022-041408

(51) Int. Cl. B41J 11/00; B41J 29/02; B41J 2/215; B41J 29/13; B41J 29/46; B41J 25/304

(52) U.S. Cl. CPC B41J 11/00214; B41J 29/02; B41J 2/215; B41J 29/13; B41J 29/46; B41J 25/304

(57) ABSTRACT

A recording apparatus includes a medium supporting part configured to support a medium, a recording unit configured to perform recording on the medium supported by the medium supporting part, an irradiation unit configured to irradiate, with irradiation light, the medium on which recording was performed by the recording unit, a deodorizing unit configured to perform deodorization, and a housing covering the medium supporting part, the recording unit, the irradiation unit, and the deodorizing unit. The deodorizing unit includes an air blaster, a first filter configured to remove a foreign matter, and a deodorizing member configured to adsorb an odor of air. The deodorizing unit exhausts air inside the housing to outside of the housing by causing the air inside the housing to flow through the first filter and the deodorizing member by driving the air blaster.

The present application is based on, and claims priority from JP Application Serial Number 2022-041408, filed Mar. 16, 2022, the disclosure of which is hereby incorporated by reference herein in its entirety.

### BACKGROUND

### 1. Technical Field

The present disclosure relates to a recording apparatus.

### 2. Related Art

In the related art, recording apparatuses having a function of cleaning odors of ink are known. For example, JP-A-2018-140530 discloses a printing apparatus including a printing unit, a housing that houses the printing unit and a gas cleaning unit that cleans gas. The gas cleaning unit is located outside the housing, and communicates with the inside of the housing through an ejection unit and a supply unit. The gas inside the housing sequentially flows and circulates through the ejection unit, the gas cleaning unit and the supply unit, and is cleaned by the gas cleaning unit.

As disclosed in JP-A-2018-140530, deodorizing apparatuses used for known recording apparatuses have a large size, and consequently the space required for installation is large.

### SUMMARY

A recording apparatus according to an aspect of the present disclosure includes a medium supporting part configured to support a medium, a recording unit configured to perform recording on the medium supported by the medium supporting part, an irradiation unit configured to irradiate, with irradiation light, the medium on which recording was performed by the recording unit, a deodorizing unit configured to perform deodorization, and a housing covering the medium supporting part, the recording unit, the irradiation unit, and the deodorizing unit, wherein the deodorizing unit includes an air blaster, a first filter configured to remove a foreign matter, and a deodorizing member configured to adsorb an odor of air and the deodorizing unit exhausts air inside the housing to outside of the housing by causing the air inside the housing to flow through the first filter and the deodorizing member by driving the air blaster.

### BRIEF DESCRIPTION OF THE DRAWINGS

FIG. 1 is a perspective view of a recording apparatus according to the embodiment.

FIG. 2 is a plan view of the recording apparatus.

FIG. 3 is a perspective view of the recording apparatus.

FIG. 4 is a perspective view of a main part of the recording apparatus.

FIG. 5 is a perspective view of a deodorizing unit.

FIG. 6 is a perspective view of the deodorizing unit.

FIG. 7 is a perspective view of a main part of the recording apparatus.

FIG. 8 is a perspective view of a main part of the deodorizing unit.

FIG. 9 is a block diagram of a recording apparatus 1.

FIG. 10 is a perspective view of a main part of a recording apparatus according to another embodiment.

### DESCRIPTION OF EXEMPLARY EMBODIMENTS

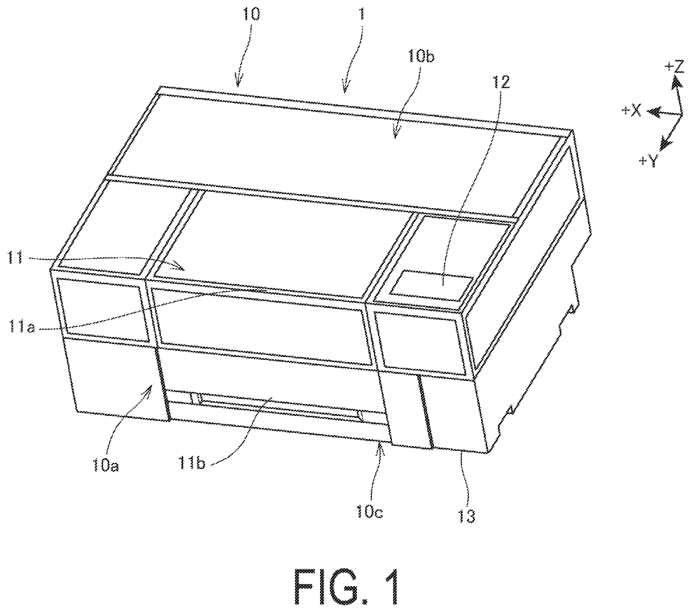

FIG. 1 is a perspective view of a recording apparatus 1 according to an embodiment. The recording apparatus 1 is an apparatus that performs recording on a medium M supported at a medium supporting part 30 by ejecting liquid from a recording head 89a. The medium M is a sheet, a cloth, or a three-dimensional object. The sheet may be paper, or a sheet made of synthetic resin. The cloth may be a non-woven cloth, a knitted cloth, or a woven cloth. The three-dimensional object includes clothing, shoes and other decorations, household items, machine parts, and various other objects. The type of the liquid to be ejected by the recording apparatus 1 to the medium M is not limited as long as it has fluidity. For example, the recording apparatus 1 is a printer that forms an image on the medium M by jetting ink of one or more colors to the surface of the medium M from the recording head 89a. In this case, the medium M corresponds to a printing medium.

FIG. 1 illustrates the X axis, the Y axis, and the Z axis. The X axis, the Y axis, and the Z axis are orthogonal to each other. The Z axis is an axis extending in the up-down direction, or may be referred to as an axis extending in the vertical direction. The X axis and the Y axis are parallel to the horizontal plane. In the following description, the direction along the X axis is the left-right direction, and the direction along the Y axis is the front-rear direction. Specifically, the positive direction along the Z axis is the upward direction, the positive direction along the X axis is the right direction, and the positive direction along the Y axis is the front direction. The front direction corresponds to an example of “first direction”. The Y axis corresponds to an example of “first axis”. The X axis corresponds to an example of “second axis”.

The recording apparatus 1 includes a housing 10. The housing 10 is a substantially cuboid box, and forms a closed space inside. The housing 10 covers the medium supporting part 30, the recording head 89a, an irradiation unit 89b, a deodorizing unit 20, and the like that are described later, and houses them in the closed space. The housing 10 includes a first cover 11 extending along a front surface 10a and a top surface 10b. The first cover 11 includes a cover body 11a extending along the front surface 10a and the top surface 10b and a grip 11b coupled with the lower end of the cover body 11a. The first cover 11 is coupled to the top surface 10b of the housing 10 so as to be rotatable about the left-right direction with a hinge at the rear end of the cover body 11a. Therefore, when the grip 11b is moved in the up-down direction, the first cover 11 can be opened and closed from the front direction. In addition, the housing 10 includes, at a bottom surface 10c, a bottom plate 13, which is a plate that faces the installation surface of the housing 10. The installation surface is a surface where the housing 10 is installed, such as the top surface of a desk (not illustrated). The bottom plate 13 is an example of “bottom surface part”.

The recording apparatus 1 includes a display unit 12 disposed at a front part of the top surface 10b. The display unit 12 is composed of a liquid crystal panel and a light-emitting diode (LED), for example. Under the control of a control unit 90 described later, the display unit 12 displays information such as the progress of the recording at the recording apparatus 1, the residual quantity of the liquid ejected in the record, and the replacement timing of consumables at the deodorizing unit 20 described later. The display of the information relating to the replacement timing of consumables at the deodorizing unit 20 in the display unit 12 is an example of notification.

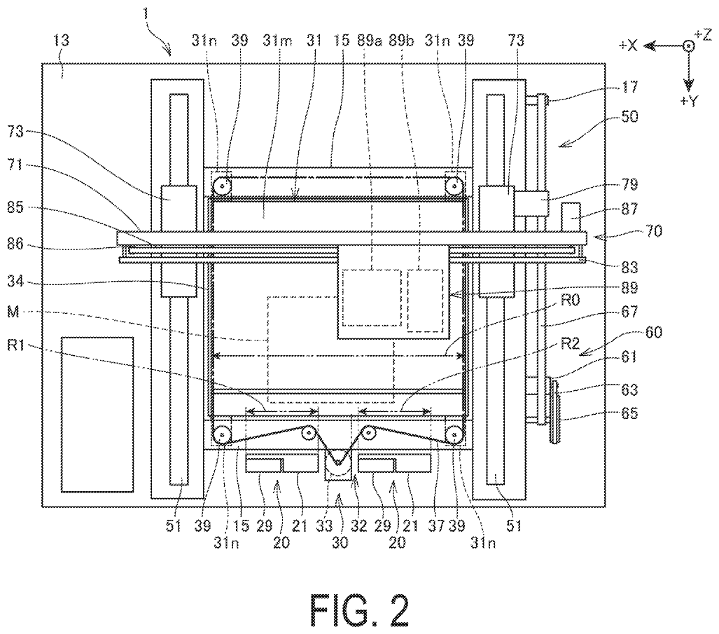

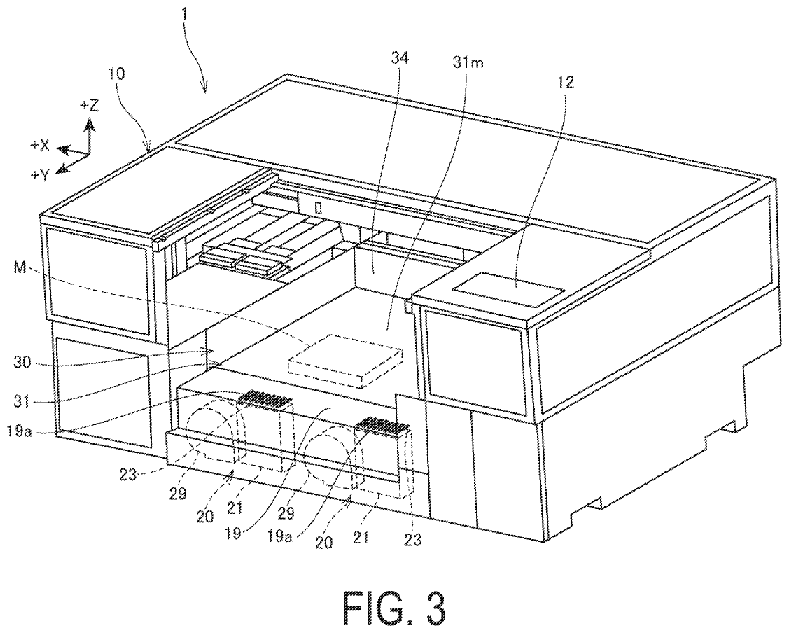

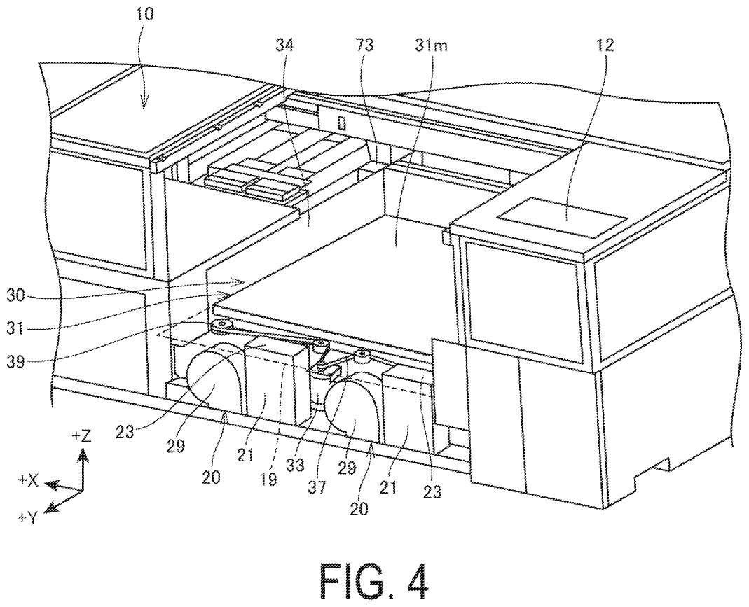

FIG. 2 is a plan view of the recording apparatus 1, and schematically illustrates an internal structure of the recording apparatus 1. FIG. 3 is a perspective view of the recording apparatus 1, and illustrates a state where the first cover 11 is removed for the sake of illustration. FIG. 4 is a perspective view of a main part of the recording apparatus 1, and illustrates an internal structure of the recording apparatus 1.

As illustrated in FIG. 2, the recording apparatus 1 includes a pair of base members 15, a pair of guide shafts 51, the deodorizing unit 20, the medium supporting part 30, a driving mechanism 50, and a movement unit 70. A base member 15 is a member extending in the left-right direction. The two base members 15 are disposed side by side in the front-rear direction on the bottom plate 13, and fixed to the bottom plate 13. The guide shafts 51 are shafts extending in the front-rear direction, and the two guide shafts 51 are disposed side by side in the left-right direction over two base members 15. The deodorizing unit 20 sucks air from the inside of the housing 10, deodorizes the sucked air, and exhausts the deodorized air to the outside of the housing 10. Details of the deodorizing unit 20 are described later.

The medium supporting part 30 supports the medium M serving as a recording object in the recording apparatus 1. As illustrated in FIGS. 2 to 4, the medium supporting part 30 includes a table 31, a fall prevention plate 34, and a height moving mechanism 32. The table 31 is disposed at a position surrounded by the pair of base members 15 and the pair of guide shafts 51 in plan view. The table 31 includes a support surface 31m, which is a rectangular surface that extends along the X axis and the Y axis and faces upward. The support surface 31m corresponds to an example of “placing surface”.

The support surface 31m is a surface where the medium M is placed in the medium supporting part 30, and supports the medium M placed on the support surface 31m. As illustrated in FIGS. 3 and 4, in the state where the first cover 11 is opened, the support surface 31m is exposed to the front side and upper side of the housing 10. Thus, in the state where the first cover 11 is opened, the medium M outside the housing 10 can be set to the support surface 31m of the medium supporting part 30 from the front side of the support surface 31m. In addition, in the state where the first cover 11 is opened, the medium M placed on the support surface 31m of the medium supporting part 30 can be taken out to the outside of the housing 10.

In addition, the table 31 includes a protrusion 31n protruding to the outside of the support surface 31m in plan view at the lower portions of the four corners of the support surface 31m. With the protrusion 31n fixed to a lifting mechanism 39 described later, the table 31 is supported such that it is vertically movable with respect to the base member 15.

The fall prevention plate 34 is a plate-shaped member provided vertically upright in contact with the left side, right side, and rear side of the support surface 31m. In other words, the fall prevention plate 34 is perpendicular to the support surface 31m, and surrounds the support surface 31m from the left-right sides and rear side along the end portion of the support surface 31m. The front side of the support surface 31m is open with no fall prevention plate 34.

The fall prevention plate 34 is formed by bending a sheet metal. The fall prevention plate 34 is disposed at the periphery of the support surface 31m so that the medium M far smaller than the support surface 31m does not fall from the support surface 31m, for example. As described later, the support surface 31m is vertically movable, and the fall prevention plate 34 is fixed to prevent vertical movement. The fall prevention plate 34 extends in a range including a lowest position to a highest position of the support surface 31m in the height direction. Therefore, it can be said that at least a part of the fall prevention plate 34 is located above the support surface 31m when the support surface 31m is located at the lowest position.

The height moving mechanism 32 is a mechanism that moves the table 31 up and down and allows the vertical movement of the support surface 31m and the medium M supported by the support surface 31m. That is, the support surface 31m is configured to be able to vertically move with the height moving mechanism 32. The height moving mechanism 32 includes a vertical moving motor 33, a vertical movement belt 37, and the lifting mechanism 39. The lifting mechanism 39 includes a ball screw, a nut threadedly engaged with the ball screw, and a pulley disposed along the vertical direction. The ball screw of the lifting mechanism 39 is rotatably supported by the base member 15. The nut of the lifting mechanism 39 is fixed to the protrusion 31n of the table 31. The pulley of the lifting mechanism 39 is fixed to an upper part of the ball screw. When the pulley of the lifting mechanism 39 rotates, the ball screw rotates, and the protrusion 31n moves along the vertical direction together with the nut along with the rotation of the ball screw.

The vertical moving motor 33 is a motor that rotates under the control of the control unit 90 described below. The control unit 90 controls the rotational direction and rotation amount of the vertical moving motor 33. The vertical movement belt 37 is an annular belt provided across the output shaft of the vertical moving motor 33 and the pulleys of the four lifting mechanisms 39. When the vertical moving motor 33 rotates, the vertical movement belt 37 is driven into circulation. The vertical movement belt 37 transmits the rotation of the vertical moving motor 33 to the pulleys of the four lifting mechanisms 39. In this manner, the ball screw of the lifting mechanism 39 rotates to move the table 31 along the vertical direction.

The rotational direction of the vertical moving motor 33 can be switched between the positive direction of moving the table 31 upward and the opposite direction of moving the table 31 downward. The recording apparatus 1 moves the table 31 up and down by operating the vertical moving motor 33.

The driving mechanism 50 includes the pair of guide shafts 51 and a frame driving unit 60. The guide shaft 51 is a shaft member provided across the pair of base members 15 and disposed along the front-rear direction.

The frame driving unit 60 includes a frame moving motor 61, a transmission belt 63, a transmission mechanism 65, and a transmission belt 67. The frame moving motor 61 is a motor that rotates under the control of the control unit 90 described later. The transmission belt 63 is an annular belt provided across the output shaft of the frame moving motor 61 and the transmission mechanism 65, and transmits the driving force of the frame moving motor 61 to the transmission mechanism 65. The transmission mechanism 65 includes a first pulley and a second pulley. The transmission belt 63 is wound around the first pulley, and the transmission belt 67 is wound around the second pulley. The transmission mechanism 65 drives the transmission belt 67 by rotating the second pulley with the driving force transmitted from the transmission belt 63 to the first the pulley. The transmission mechanism 65 transmits the driving force of the frame moving motor 61 to the transmission belt 67 at a reduction ratio corresponding to the diameter ratio between the first pulley and the second pulley.

The transmission belt 67 is an annular belt provided across the transmission mechanism 65 and a frame movement pulley 17 disposed at an end portion on the rear side of the base member 15. The frame movement pulley 17 is a pulley installed in a rotatable manner with respect to the base member 15. The transmission belt 67 is disposed along the guide shaft 51.

The movement unit 70 includes a main frame 71, a pair of leg parts 73, and a carriage 89. The main frame 71 is a plate-shaped member elongated in the left-right direction. The pair of leg parts 73 is fitted to the pair of guide shafts 51, and is movable along the guide shaft 51. The main frame 71 is fixed on the pair of leg parts 73, and is supported by the pair of leg parts 73 from below. The main frame 71 is guided by the pair of guide shafts 51 together with the pair of leg parts 73, and moved in the front-rear direction.

Through a belt coupling part 79, the transmission belt 67 is fixed to the leg part 73 that supports the left end of the main frame 71 of the pair of leg parts 73. In this manner, when the transmission belt 67 is driven into circulation, a power that moves the leg part 73 in the front-rear direction acts on the leg part 73. As a result, the movement unit 70 moves in the front-rear direction. Note that the lower end of the main frame 71 is located above the support surface 31m when the table 31 is located uppermost. Thus, the main frame 71 moves in the front-rear direction above the support surface 31m without interfering with the support surface 31m.

The rotational direction of the frame moving motor 61 can be switched between the positive direction of moving the main frame 71 frontward and the opposite direction of moving the main frame 71 rearward. The recording apparatus 1 moves the main frame 71 forward and rearward by operating the frame moving motor 61.

The carriage 89 is a substantially cuboid box, and is supported by the main frame 71 through a carriage guide shaft 83. The carriage guide shaft 83 is a shaft member fixed to the main frame 71, and extends in the left-right direction along the main frame 71. The carriage guide shaft 83 supports the carriage 89 such that it is movable in the left-right direction. Note that the lower end of the carriage 89 is located above the support surface 31m when the table 31 is located uppermost. Thus, the carriage 89 moves in the front-rear direction and left-right direction above the support surface 31m without interfering with the support surface 31m.

In addition, the carriage 89 is coupled with a carriage drive belt 85. The carriage drive belt 85 is an annular belt disposed along the carriage guide shaft 83 with one end provided around a carriage drive pulley 86 and the other end provided around the output shaft of a carriage driving motor 87. The carriage drive pulley 86 is a pulley rotatably fixed to the right end of the main frame 71. The carriage driving motor 87 is a motor fixed to the left end of the main frame 71, the output shaft of which is rotated under the control of the control unit 90 described later. By rotating the output shaft, the carriage driving motor 87 drives the carriage drive belt 85 into circulation. In this manner, the carriage driving motor 87 moves the carriage 89 coupled with the carriage drive belt 85 in the left-right direction along the carriage guide shaft 83.

The carriage 89 includes the recording head 89a and the irradiation unit 89b. The recording head 89a includes a plurality of nozzles (not illustrated) that open downward from the lower end surface of the carriage 89. The recording head 89a ejects liquid from the nozzles through the driving of a piezo actuator (not illustrated). When the recording head 89a ejects the liquid from the nozzles, the ejected liquid flies between the nozzle and the medium M placed on the table 31 and impinges on the medium M. Note that, in this embodiment, the liquid ejected by the recording head 89a from the nozzles is ink that is cured by ultraviolet rays. By applying the liquid onto the medium M on the medium supporting part 30, the recording head 89a records characters and images formed of the liquid on the medium M. The recording head 89a corresponds to an example of “recording unit”.

The irradiation unit 89b includes an irradiation window (not illustrated) that faces downward from the lower end surface of the carriage 89. The irradiation window is composed of a plate composed of an optically transparent material. The irradiation unit 89b emits irradiation light from a light source unit (not illustrated) through the irradiation window. The irradiation light emitted from the irradiation unit 89b passes between the irradiation window and the medium M placed on the table 31, and irradiates the medium M on which recording was performed by the recording head 89a. In this embodiment, the irradiation unit 89b includes an ultraviolet light-emitting diode (UV-LED) that emits ultraviolet rays, and the irradiation light is an ultraviolet ray. That is, in this embodiment, the irradiation unit 89b irradiates, with ultraviolet ray, the ink that is cured by the ultraviolet ray impinging on the medium M, and firmly fixes the ink to the medium M.

### 2. Configuration of Deodorizing Unit

As illustrated in FIGS. 2 to 4, two deodorizing units 20 are disposed side by side in the left-right direction on the front side of the support surface 31m of the medium supporting part 30 and inside of the housing 10. In addition, the two deodorizing units 20 are provided in a range R1 and a range R2 respectively in the X axis. Both the range R1 and the range R2 overlap, in their entirety in the X axis, a range R0 where the support surface 31m is provided. That is, the entirety of the two deodorizing units 20 is provided in the range overlapping the support surface 31m in the X axis. The two deodorizing units 20 are detachably fixed to the bottom plate 13 by screw fastening.

The recording apparatus 1 includes a second cover 19 that covers the upper side of the two deodorizing units 20. The second cover 19 is a plate-shaped member that is disposed approximately horizontally. The second cover 19 is attachable to and detachable from the base member 15. Regarding the position of the second cover 19 in the height direction, the top surface corresponds to the lowermost part of the movable range of the support surface 31m. That is, when the support surface 31m is located at the lowest position, the support surface 31m and the top surface of the second cover 19 are flush. At this time, the second cover 19 and the front edge of the support surface 31m are in contact or substantially in contact with each other. A ventilation hole 19a extending through the second cover 19 in the vertical direction is formed in the second cover 19. The ventilation hole 19a is a hole elongated in the front-rear direction, and a plurality of the ventilation holes 19a are formed side by side in the left-right direction in the second cover 19.

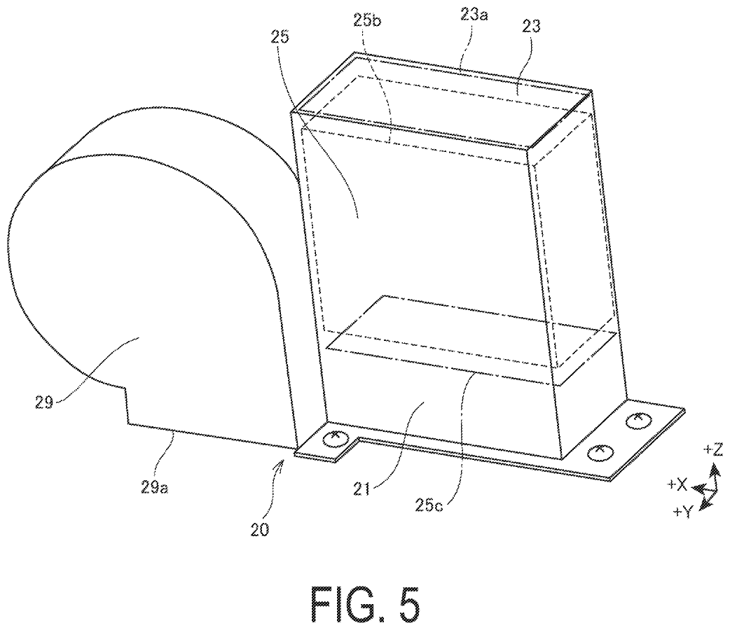

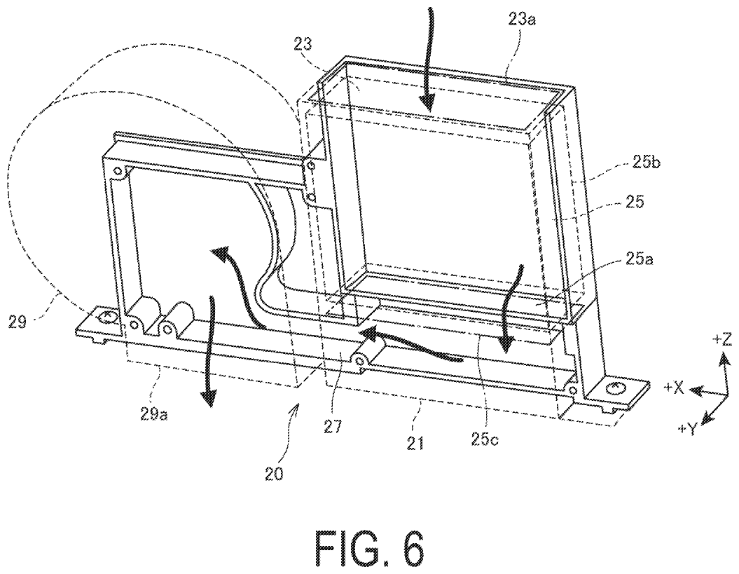

FIG. 5 is a perspective view of the deodorizing unit 20. FIG. 6 is a perspective view of the deodorizing unit 20 and illustrates a sectional view of a cross-section perpendicular to the front-rear direction. The deodorizing unit 20 includes a deodorizing duct 21. The deodorizing duct 21 is a hollow metal duct, and the deodorizing duct 21 is located immediately below the ventilation hole 19a in the state where the deodorizing unit 20 is mounted in the recording apparatus 1. The deodorizing duct 21 includes a suction port 23, a body part 25, and an air blaster coupling unit 27. The deodorizing duct 21 is coupled to an air blaster 29 at the air blaster coupling unit 27, and air flows inside the deodorizing duct 21 through the driving of the air blaster 29.

The suction port 23 opens at the upper end of the deodorizing duct 21 and the suction port 23 overlaps the ventilation hole 19a in plan view in the state where the deodorizing unit 20 is mounted in the recording apparatus 1. Therefore, the upper space of the second cover 19 and the inner space of the deodorizing duct 21 communicate with each other through the ventilation hole 19a and the suction port 23. The suction port 23 is located below the second cover 19, and therefore, comparing the positions of the suction port 23 and the support surface 31m in the height direction, the suction port 23 is at a position at the same height as or lower than the lowest position of the movable range of the support surface 31m. In addition, the suction port 23 is located at a position not overlapping the support surface 31m in plan view.

The body part 25 is a hollow portion extending downward from the suction port 23. A bedding plate 25a that covers the body part 25 from below is provided at the lower end of the body part 25. The bedding plate 25a includes a large number of holes extending through it in the up-down direction, and passes air through it in the vertical direction while supporting a deodorizing member 25b described later. The hollow air blaster coupling unit 27 is formed in the right direction from lower end of the body part 25. At the right end, the air blaster coupling unit 27 is coupled to the suction port of the air blaster 29 in the front-rear direction. The air blaster 29 is a centrifugal air blaster, in which, when driven by a motor (not illustrated), a stacking wheel (not illustrated) rotates, causing air to be sucked from the air blaster coupling unit 27 on the rear side through the suction port. The air blaster 29 exhausts the sucked air provided at the lower end of the air blaster 29 from an ejecting port 29a. Specifically, through the driving of the air blaster 29, the deodorizing unit 20 sucks air from the inside of the housing 10 through the ventilation hole 19a and the suction port 23. In addition, the deodorizing unit 20 causes the sucked air to sequentially flow through the body part 25, the air blaster coupling unit 27, and the ejecting port 29a.

In addition, the suction port 23 is provided with a breathable first filter 23a so as to cover the entire surface of the suction port 23 from above. The first filter 23a is a coarse filter composed of a non-woven fabric with air permeability, for example. The first filter 23a removes foreign matters such as ink mist and dust larger than the mesh of the first filter 23a from the air passing through the suction port 23, for example. The first filter 23a is a consumable, and its performance decreases due to clogging, smudge, or degradation as it is used. The first filter 23a is placed on the suction port 23, and thus can be easily attached to and detached from the deodorizing unit 20. Therefore, the first filter 23a with reduced performance can be easily replaced with a new first filter 23a.

Further, the body part 25 is provided with the deodorizing member 25b with air permeability that adsorbs odors of air. The deodorizing member 25b is composed of a large number of fine pellets containing activated carbon that are enclosed in a net with a bag shape with a mesh finer than the pellets, for example. The deodorizing member 25b is spread over the substantially entire inner space of the body part 25. The air flown into the body part 25 flows through the voids between the pellets of the deodorizing member 25b, for example. At this time, the odor components of the air are absorbed and removed by the activated carbon component contained in the pellets of the deodorizing member 25b. The deodorizing member 25b is a consumable of which the performance decreases as it is used. The deodorizing member 25b is placed on the bedding plate 25a. Therefore, the deodorizing member 25b can be easily attached to and detached from the deodorizing unit 20 through the suction port 23 by detaching the first filter 23a. Thus, the deodorizing member 25b with reduced performance can be easily replaced with a new deodorizing member 25b.

In addition, the body part 25 includes a second filter 25c placed on the bedding plate 25a and disposed below the deodorizing member 25b. The second filter 25c is a filter composed of a glass fiber with air permeability, for example. The second filter 25c removes fine particles in the air that cannot be removed by the first filter 23a and the deodorizing member 25b. The second filter 25c is a consumable of which the performance decreases as it is used. The second filter 25c can be easily attached and detached through the suction port 23 in the state where the first filter 23a and the deodorizing member 25b are detached from the deodorizing duct 21. Thus, the second filter 25c with reduced performance can be easily replaced with a new second filter 25c.

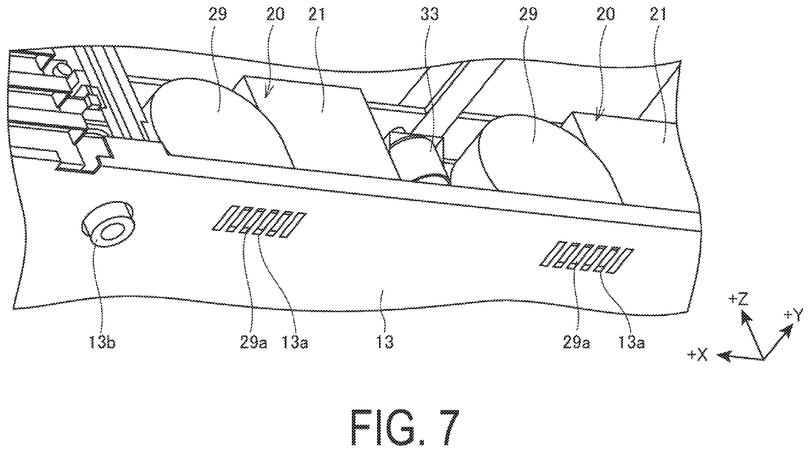

FIG. 7 is a perspective view of a main part of the recording apparatus 1, and illustrates the main part of the recording apparatus 1 as viewed from the lower side. As illustrated in FIG. 7, the bottom plate 13 of the housing 10 includes an exhaust hole 13a and a housing leg part 13b. The exhaust hole 13a is a hole for communication between the inside and outside of the housing 10. The exhaust hole 13a is composed of a plurality of long holes extending in the front-rear direction and arranged in the left-right direction, and is provided immediately below the ejecting port 29a of the air blaster 29. The housing leg parts 13b are provided at the four corners of the bottom plate 13 in plan view. The housing leg part 13b is a portion that has a shape protruding downward from the bottom plate 13 and that is brought into contact with the installation surface when the recording apparatus 1 is installed. Thus, the housing leg part 13b provides a gap between the bottom plate 13 and the installation surface.

In this manner, the deodorizing unit 20 causes the air inside the housing 10 to flow through the first filter 23a, the deodorizing member 25b, and the second filter 25c through the driving of the air blaster 29, and thereby exhausts the air to the outside of the housing 10 through the exhaust hole 13a. The air exhausted from the exhaust hole 13a flows through the gap between the bottom plate 13 and the installation surface.

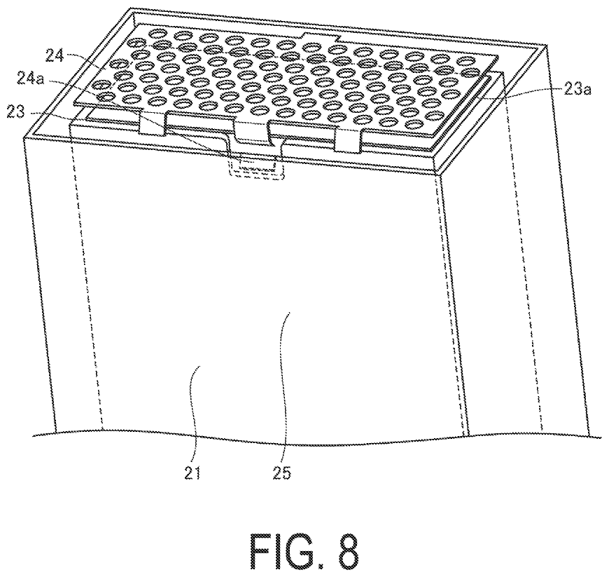

FIG. 8 is a perspective view of a main part of the deodorizing unit 20, and illustrates a configuration in which a punching metal 24 is placed at the suction port 23. The punching metal 24 is composed of a metal sheet provided with a plurality ventilation holes, and can be attached to the suction port 23. The punching metal 24 includes a grounding protrusion 24a configured to be inserted to the body part 25 of the deodorizing duct 21. The grounding protrusion 24a electrically couples the deodorizing member 25b and the housing 10 through the deodorizing duct 21 by coming into contact with the deodorizing member 25b. In this manner, the deodorizing member 25b is grounded.

### 3. Configuration of Control System of Recording Apparatus

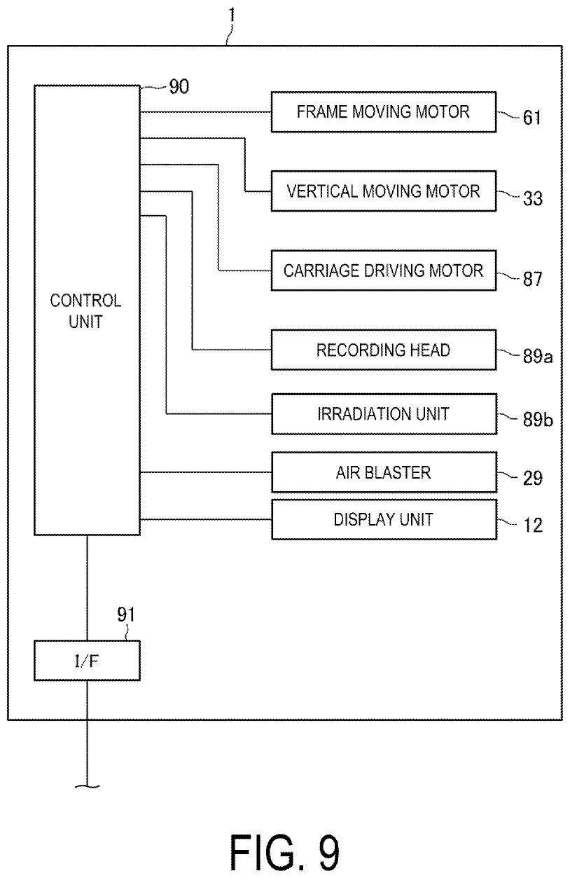

FIG. 9 is a block diagram of the recording apparatus 1, and illustrates a functional configuration of a control system of the recording apparatus 1.

The recording apparatus 1 includes the control unit 90. The control unit 90 includes a processor such as a central processing unit (CPU) and micro processing unit (MPU), and a storage unit. The storage unit of the control unit 90 includes a volatile memory and a nonvolatile storage unit. The volatile memory is a random-access memory (RAM), for example. The nonvolatile storage unit is composed of a read only memory (ROM), a hard disk, a flash memory, or the like. The control unit 90 controls each unit of the recording apparatus 1 by executing the program stored in the storage unit.

An interface (I/F) 91 is coupled to the control unit 90. The interface 91 is a communication apparatus that performs wired communication using a cable, or radio communication using a wireless communication line. The interface 91 receives record data by communicating with a host computer (not illustrated). The record data includes data of images and characters to be recorded on the medium M by the recording apparatus 1, a command instructing performance of recording by the recording apparatus 1, and other data.

The vertical moving motor 33, the frame moving motor 61, the carriage driving motor 87, and the recording head 89a are coupled to the control unit 90. In addition, the display unit 12 and the air blaster 29 are coupled to the control unit 90. The control unit 90 controls the vertical movement of the support surface 31m by controlling the vertical moving motor 33, for example.

The control unit 90 operates each motor based on the record data received by the interface 91. Specifically, the control unit 90 moves the movement unit 70 in the front-rear direction by controlling the switching of the rotational direction of the frame moving motor 61 and the start and stop of the rotation of the frame moving motor 61. The control unit 90 moves the table 31 in the up-down direction by controlling the switching of the rotational direction of the vertical moving motor 33 and the start and stop of the rotation of the vertical moving motor 33. The control unit 90 moves the carriage 89 in the left-right direction by controlling the switching of the carriage driving motor 87 and the start and stop of the rotation of the carriage driving motor 87.

The control unit 90 ejects the liquid by operating the recording head 89a based on the record data received by the interface 91. The control unit 90 causes the display unit 12 to display information by operating the display unit 12. The control unit 90 operates the air blaster 29 to deodorize the air inside the housing 10 and exhaust the deodorized air to the outside of the housing 10.

### 4. Operation of Recording Apparatus

4.1. Operation During Recording

When the recording apparatus 1 performs recording on the medium M, first, the control unit 90 drives the vertical moving motor 33 and optimizes the gap between the support surface 31m and the recording head 89a. Next, the control unit 90 drives the frame moving motor 61 and the carriage driving motor 87 to move the main frame 71 from the front side to the rear side and move the carriage 89 from the left side to the right side. Simultaneously, the control unit 90 performs recording by ejecting the liquid from the recording head 89a to the medium M based on the record data. In addition, the control unit 90 fixes the liquid adhered to the medium M to the medium M by irradiating, with light from the irradiation unit 89b, the medium M on which recording was performed.

When the recording apparatus 1 performs the recording in the above-described manner, mist of the liquid ejected by the recording head 89a is generated inside the housing 10. In addition, the air inside the housing 10 has unpleasant odors due to the liquid ejected from the recording head 89a.

While the recording apparatus 1 is performing the recording, the control unit 90 drives the air blaster 29. In this manner, the air with unpleasant odors and the mist of the housing 10 flow into the deodorizing duct 21 through the ventilation hole 19a and the suction port 23. At this time, the first filter 23a provided to cover the suction port 23 removes most of the mist.

Thereafter, the air with unpleasant odors passes through the body part 25. At this time, the deodorizing member 25b provided in the body part 25 absorbs and removes most of the components in the air that cause unpleasant odors. Further, the air past the deodorizing member 25b passes through the second filter 25c. At this time, the particles remaining in the air are further removed from the air, and flow into the air blaster coupling unit 27 as clean air.

The clean air flown into the air blaster coupling unit 27 is sucked from the suction port of the air blaster 29, and ejected from the ejecting port 29a. The air ejected from the ejecting port 29a is exhausted to the outside of the housing 10 from the exhaust hole 13a provided in the bottom plate 13 of the housing 10, and flows between the bottom plate 13 and the installation surface.

4.2. Operation at Completion of Recording

When the recording to the medium M is completed, the control unit 90 drives the vertical moving motor 33 in the state where the air blaster 29 is driven, and moves the support surface 31m to the lowest position.

As described above, the medium supporting part 30 is provided with the fall prevention plate 34 that is perpendicular to the support surface 31m and surrounds the support surface 31m along the end portion of the support surface 31m. Thus, when the support surface 31m moves downward, the air on the upper side of the support surface 31m is guided by the fall prevention plate 34 to flow downward following the support surface 31m. In addition, the fall prevention plate 34 extends along the edges of the left side, right side, and rear side of the support surface 31m, and is open on the front side of the support surface 31m. Thus, the air flown downward following the support surface 31m flows to the front side from the support surface 31m, i.e., toward the ventilation hole 19a.

Thus, by moving the support surface 31m to the lowermost portion by driving the vertical moving motor 33 at the completion of the recording, the air inside the housing 10 flows to the ventilation hole 19a. Therefore, the air inside the housing 10 can be quickly deodorized after the completion of the recording. The control unit 90 stops the air blaster 29 after a predetermined time has elapsed after driving the vertical moving motor 33 and moving the support surface 31m to the lowermost portion.

4.3. Operation When Performance of Consumable of Deodorizing Unit is Reduced

As described above, in the deodorizing unit 20, the first filter 23a, the deodorizing member 25b, and the second filter 25c are consumables, and their performance is reduced as they are used. The recording apparatus 1 determines reduction in performance of the consumables of the deodorizing unit 20 and performs notification to prompt the user to replace them.

The control unit 90 stores the time when each consumable was last replaced by receiving input from the user, for example. In addition, the control unit 90 stores for each consumable the cumulative amount of the liquid ejected by the recording head 89a after the time when each consumable was last replaced. For example, the cumulative ejection amount of the liquid after the first filter 23a was last replaced is referred to as Q1, the cumulative ejection amount of the liquid after the deodorizing member 25b was last replaced as Q2, and the cumulative ejection amount of the liquid after the second filter 25c was last replaced as Q3. For example, when the cumulative ejection amount Q1 of the liquid exceeds a first predetermined value, the control unit 90 determines that the performance of the first filter 23a is reduced. Likewise, for example, when the cumulative ejection amount Q2 exceeds a second predetermined value, the control unit 90 determines that the performance of the deodorizing member 25b is reduced. In addition, for example, when the cumulative ejection amount Q3 exceeds a third predetermined value, the control unit 90 determines that the performance of the second filter 25c is reduced. That is, with the control unit 90, the recording apparatus 1 can detect reduction in performance of the first filter 23a, the deodorizing member 25b, and the second filter 25c.

When detecting reduction in performance of the first filter 23a, the deodorizing member 25b, or the second filter 25c, the control unit 90 controls the display unit 12 to display an indication to prompt replacement of the consumable of which reduction in performance is detected, on the liquid crystal panel of the display unit 12. That is, when reduction in performance of the first filter 23a, the deodorizing member 25b, or the second filter 25c is detected by the control unit 90, the recording apparatus 1 performs notification to prompt replacement of the first filter 23a, the deodorizing member 25b, or the second filter 25c.

When the notification to prompt replacement of consumables is performed in the above-described manner, the consumable corresponding to the notification is replaced by the user at the deodorizing unit 20. In the replacement of the consumables of the deodorizing unit 20, the first cover 11 and the second cover 19 are opened, and then the consumable of the deodorizing unit 20 is replaced. At this time, the first cover 11 opens from the front side, and the second cover 19 and the deodorizing unit 20 are located on the front side of the support surface 31m. Thus, the user can easily replace the corresponding consumable from the front side.

### 5. Effects, etc.

As described above, the recording apparatus 1 according to the embodiment includes the medium supporting part 30 that supports the medium M, and the recording head 89a that performs recording on the medium M supported by the medium supporting part 30. In addition, the recording apparatus 1 includes the irradiation unit 89b that irradiates, with irradiation light, the medium M on which recording was performed by the recording head 89a, the deodorizing unit 20 that performs deodorization, and the housing 10 that covers the medium supporting part 30, the recording head 89a, the irradiation unit 89b, and the deodorizing unit 20. The deodorizing unit 20 includes the air blaster 29, the first filter 23a that removes foreign matters, and the deodorizing member 25b that adsorbs odors of air. The deodorizing unit 20 exhausts the air inside the housing 10 to the outside of the housing 10 by causing the air inside the housing 10 to flow through the first filter 23a and the deodorizing member 25b by driving the air blaster 29.

With this configuration, the deodorizing unit 20 can be disposed inside the housing 10. Thus, the recording apparatus 1 that can reduce the user discomfort with the deodorizing function can be downsized.

In the recording apparatus 1, the deodorizing member 25b is attachable to and detachable from the deodorizing unit 20.

With this configuration, the deodorizing member 25b can be replaced. Thus, the small deodorizing member 25b can be used while replacing it without using a large deodorizing member 25b. In this manner, the recording apparatus 1 can be downsized.

The housing 10 includes the first cover 11 that can be opened and closed from the front side, and the medium M can be placed at the medium supporting part 30 from the front side in the state where the first cover 11 is opened. In the recording apparatus 1, the deodorizing unit 20 is located on the front side of the medium supporting part 30.

With this configuration, the deodorizing member 25b can be easily replaced by opening the first cover 11. Thus, the convenience of the recording apparatus 1 is improved.

The medium supporting part 30 includes the support surface 31m, and the support surface 31m is along the Y axis along the front direction and the X axis perpendicular to the front direction, and supports the medium M. In the recording apparatus 1, the entirety of the deodorizing unit 20 is provided in the range RO that overlaps the support surface 31m in the X axis.

With this configuration, in the recording apparatus 1, the deodorizing unit 20 does not protrude to the outside of the support surface 31m. Thus, the recording apparatus 1 including the deodorizing unit 20 can be further downsized.

The recording apparatus 1 can detect reduction in performance of the deodorizing member 25b, and perform notification to prompt replacement of the deodorizing member 25b when detecting the reduction in performance of the deodorizing member 25b.

With this configuration, continuous use of the deodorizing member 25b with reduced performance can be reduced. Thus, the deodorizing performance of the deodorizing member 25b is maintained, and the user discomfort can be reduced.

In the recording apparatus 1, the housing 10 forms a closed space inside the housing 10, and houses the medium supporting part 30, the recording head 89a, the irradiation unit 89b, and the deodorizing unit 20 in the closed space.

With this configuration, in the recording apparatus 1, the air before the deodorization is performed by the deodorizing unit 20 less leaks to the outside of the housing 10. Thus, the user discomfort can be further reduced.

The housing 10 includes the bottom plate 13 that faces the installation surface where the housing 10 is installed, and the bottom plate 13 includes the exhaust hole 13a for communication between the inside and outside of the housing 10. The deodorizing unit 20 exhausts the air inside the housing 10 to the outside of the housing 10 through the exhaust hole 13a.

With this configuration, the air exhausted to the outside of the housing 10 through the exhaust hole 13a flows toward the installation surface. Thus, the air exhausted to the outside of the housing 10 does not directly hit the user, and thus the user discomfort can be reduced.

The deodorizing unit 20 includes the suction port 23 that is the opening through which the air inside the housing 10 is sucked, the medium supporting part 30 includes the support surface 31m, and the support surface 31m is configured to support the medium M and vertically move. The suction port 23 is provided at the height equal to or lower than the height of the support surface 31m when the support surface 31m is at the lowest position and is provided at a position that does not overlap the support surface 31m in plan view.

With this configuration, when the support surface 31m moves downward, the air on the upper side of the support surface 31m flows downward toward the suction port 23. Thus, the air with odors is easily sucked from the suction port 23, and the deodorizing efficiency is improved.

The medium supporting part 30 includes the fall prevention plate 34. The fall prevention plate 34 is perpendicular to the support surface 31m and surrounds the support surface 31m along the end portion of the support surface 31m. At least a part of the fall prevention plate 34 is located above the support surface 31m when the support surface 31m is at the lowest position. The fall prevention plate 34 is open in the direction of the suction port 23 as viewed from the support surface 31m.

With this configuration, when the support surface 31m moves downward, the air on the upper side of the support surface 31m is guided by the fall prevention plate 34 to flow toward the suction port 23. Thus, the air with odors is further easily sucked from the suction port 23, and the deodorizing efficiency is further improved.

The recording apparatus 1 includes the control unit 90 that controls the vertical movement of the support surface 31m. In the recording apparatus 1, when the recording on the medium M is completed, the control unit 90 moves the support surface 31m to the lowest position.

With this configuration, when the recording on the medium M in the recording apparatus 1 is completed, the air on the upper side of the support surface 31m can be caused to flow through the suction port 23. Thus, after the recording on the medium M in the recording apparatus 1 is completed, the inside of the housing 10 can be immediately deodorized.

### 6. Other Embodiments

The above embodiment is only one specific example of the application of the present disclosure. The disclosure is not limited to the configuration of the above embodiment, but can be implemented in various forms to the extent that it does not depart from the gist of the disclosure.

In the above-described embodiment, it has been described that the control unit 90 drives the air blaster 29 while the recording apparatus 1 is performing the recording on the medium M and after a predetermined time elapses after completion of the recording, but this is an example. For example, the control unit 90 may continuously drive the air blaster 29 while the power of the recording apparatus 1 is switched on. In addition, after the recording apparatus 1 completes the recoding on the medium M, the air blaster 29 may be continuously driven for a given time by the setting of the user.

In the above-described embodiment, it has been described that the control unit 90 performs notification to recommend replacement of the first filter 23a, the deodorizing member 25b, and the second filter 25c. It has been described that this notification is performed based on the cumulative liquid ejection rate of the recording head 89a after the first filter 23a, the deodorizing member 25b, and the second filter 25c were last replaced. However, this is an example. For example, the control unit 90 may be configured to perform notification when the time elapsed after the first filter 23a, the deodorizing member 25b, and the second filter 25c were last replaced exceeds a predetermined time. In addition, for example, the control unit 90 may be configured to performs notification when the number of times of the recording performed after the first filter 23a, the deodorizing member 25b, and the second filter 25c were last replaced exceeds a predetermined number of times. Further, for example, the control unit 90 may be configured to perform notification when the driving time of the air blaster 29 after the first filter 23a, the deodorizing member 25b, and the second filter 25c were last replaced exceeds a predetermined time.

In the above-described embodiment, it has been described that the control unit 90 performs notification to recommend replacement of the first filter 23a, the deodorizing member 25b, and the second filter 25c by causing the display unit 12 to display an indication to prompt replacement of each consumable, but this is an example. For example, the recording apparatus 1 may include a speaker (not illustrated), and the control unit 90 may perform notification using a voice or alarm sound by controlling the speaker. In addition, the control unit 90 may communicate with a host computer (not illustrated) through the interface 91 and cause the host computer to perform notification to prompt replacement of each consumable.

The deodorizing efficiency of the deodorizing unit 20 may be configured to be changed by the user. For example, the two deodorizing units 20 may be switchable through selection by the user between a mode of operating the air blaster 29 of one deodorizing unit 20 and a mode of operating the air blasters 29 of both deodorizing units 20. In addition, the deodorizing efficiency of the deodorizing unit 20 can be changed such that the control unit 90 controls the motor rotational frequency of the air blasters 29 of the two deodorizing units 20.

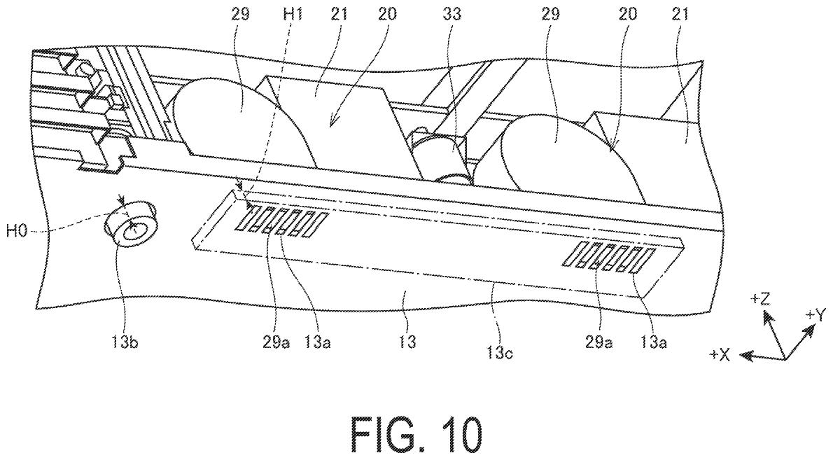

In addition, as illustrated in FIG. 10, the recording apparatus 1 may include a second deodorizing member 13c fixed on the lower side of the bottom plate 13 of the housing 10. The second deodorizing member 13c is composed of a large number of fine pellets containing activated carbon that are enclosed in a net with a bag shape with a mesh finer than the pellets, for example. A height H1 of the second deodorizing member 13c is smaller than a height H0 of the housing leg part 13b. In this manner, the second deodorizing member 13c is disposed in a gap between the bottom plate 13 and the installation surface formed by the housing leg part 13b so as to cover the exhaust hole 13a. With this configuration, when the deodorization at the deodorizing unit 20 is insufficient, deodorization can be further performed by the second deodorizing member 13c. Thus, the user discomfort can be further reduced.

What is claimed is:

1. A recording apparatus comprising:
a medium supporting part configured to support a medium;
a recording unit configured to perform recording on the medium supported by the medium supporting part;
an irradiation unit configured to irradiate, with irradiation light, the medium on which recording was performed by the recording unit;
a deodorizing unit configured to perform deodorization; and
a housing covering the medium supporting part, the recording unit, the irradiation unit, and the deodorizing unit, wherein the deodorizing unit includes an air blaster, a first filter configured to remove a foreign matter, and a deodorizing member configured to adsorb an odor of air and
the deodorizing unit exhausts air inside the housing to outside of the housing by causing the air inside the housing to flow through the first filter and the deodorizing member by driving the air blaster.

2. The recording apparatus according to claim 1, wherein the deodorizing member is attachable to and detachable from the deodorizing unit.

3. The recording apparatus according to claim 2, wherein
the housing includes a first cover openable and closable from a first direction,
the medium is placeable at the medium supporting part from the first direction in a state where the first cover is opened, and
the deodorizing unit is located on a first direction side of the medium supporting part.

4. The recording apparatus according to claim 3, wherein
the medium supporting part includes a placing surface where the medium is placed,
the placing surface is along a first axis and a second axis and supports the medium, the first axis being an axis along the first direction and the second axis being an axis perpendicular to the first direction, and
an entirety of the deodorizing unit is provided in a range overlapping the placing surface in the second axis.

5. The recording apparatus according to claim 2, wherein
the recording apparatus is configured to detect reduction in performance of the deodorizing member, and performs notification to prompt replacement of the deodorizing member when detecting the reduction in performance of the deodorizing member.

6. The recording apparatus according to claim 1, wherein
the housing forms a closed space inside the housing and
the housing houses the medium supporting part, the recording unit, the irradiation unit, and the deodorizing unit in the closed space.

7. The recording apparatus according to claim 6, wherein
the housing includes a bottom surface part facing an installation surface where the housing is installed,
the bottom surface part includes an exhaust hole for communication between inside and outside of the housing, and
the deodorizing unit exhausts the air inside the housing to the outside of the housing through the exhaust hole.

8. The recording apparatus according to claim 1, wherein
the deodorizing unit includes a suction port being an opening through which the air inside the housing is sucked,
the medium supporting part includes a support surface,
the support surface is configured to support the medium and vertically move, and
the suction port is provided at a height equal to or lower than a height of the support surface when the support surface is located at a lowest position and is provided at a position not overlapping the support surface in plan view.

9. The recording apparatus according to claim 8, wherein
the medium supporting part includes a fall prevention plate,
the fall prevention plate is perpendicular to the support surface and surrounds the support surface along an end portion of the support surface,
at least a part of the fall prevention plate is located above the support surface when the support surface is located at the lowest position, and
the fall prevention plate is open in a direction of the suction port as viewed from the support surface.

10. The recording apparatus according to claim 9, further comprising
a control unit configured to control a vertical movement of the support surface, wherein
the control unit moves the support surface to the lowest position when recording on the medium is completed.
